(19) United States
(12) Patent Application Publication
(10) Pub. No.: US 2001/0019043 A1
(43) Pub. Date: Sep. 6, 2001

(54) Method and apparatus for the laser cutting of stainless steel, coated steel, aluminium or aluminium alloys with a bifocal optical component

(76) Inventors: Christophe Bertez, Vaureal (FR); Jean Hamy, Montigny Les Cormeille (FR); Olivier Matile, Paris (FR)

Correspondence Address: YOUNG & THOMPSON, 745 SOUTH 23RD STREET 2ND FLOOR, ARLINGTON, VA, 22202

(21) Appl. No.: 09/755,053

(22) Filed: Jan. 8, 2001

(30) Foreign Application Priority Data
Jan. 10, 2000 (FR) 0000231

(51) Int. Cl. B23K 26/38; B23K 26/14

(52) U.S. Cl. 219/121.67; 219/121.75; 219/121.84

(57) ABSTRACT

Method and apparatus for cutting a workpiece made of stainless steel, coated steel, aluminum or aluminum alloy by the use of a transparent or reflecting optical means for focusing a laser beam and of an assist gas for said laser beam. The optical means is of the multifocus type and is chosen from lenses, mirrors and combinations thereof. The assist gas is oxygen or a nitrogen/oxygen mixture containing at least 90% nitrogen. The method of the invention makes it possible to increase the cutting performance by 40% compared with a conventional laser cutting method.

The present invention relates to a method and an apparatus for cutting stainless steels, coated steels, aluminum and aluminum alloys by a laser beam, using at least one lens or at least one bifocal mirror to focus the laser beam at least two focusing points separate from one another and lying on the same axis, and using oxygen or an oxygen/nitrogen mixture as assist gas for the laser beam.

Stainless steels, coated steels, aluminum and aluminum alloys are usually cut by a laser beam using nitrogen or oxygen as assist gas, also called cutting gas.

However, the use of nitrogen results in considerably limited cutting rates and in high gas consumption.

The use of oxygen makes it possible to remedy the above mentioned problems, but its use has the drawbacks of severely oxidizing the cut faces and of increasing their roughness, that is to say of reducing the quality of the cut.

Consequently, it has been proposed to use nitrogen/oxygen mixtures instead of either nitrogen or oxygen so as to try to improve the performance of the cutting method compared with cutting under pure nitrogen or under pure oxygen.

However, hitherto, such nitrogen/oxygen mixtures used with conventional lenses or optical components have not been really effective in laser cutting on an industrial scale.

At the present time there is therefore a need for an effective laser cutting method for stainless steels, coated steels, aluminum and aluminum alloys which will make it possible to achieve a cut of high quality at a high rate.

Consequently, the object of the present invention is to improve the existing methods of cutting stainless steel, coated steels, aluminum and aluminum alloys with a laser beam, that is to say to provide a laser cutting method which limits the oxidation of the cut faces while at the same time increasing the cutting performance by about 40% compared with a laser cutting method using pure nitrogen and resulting in a 30% reduction in the roughness compared with a laser cutting method using oxygen.

The present invention therefore relates to a method of cutting a workpiece made of stainless steel, coated steel, aluminum or aluminum alloy by the use of at least one transparent or reflecting optical means for focusing at least one laser beam and of at least one assist gas for said laser beam, in which the optical means is of the multifocus type and the assist gas is oxygen or an oxygen mixture nitrogen, preferably containing at least 90% nitrogen.

In the case of the present invention, the expression “optical means of the multifocus type” is understood to mean that the optical means, for example a lens, makes it possible to focus the laser beam at several focusing points separated from one another, usually a first and a second separate focusing points, which points generally lie on an axis approximately coaxial with the axis of the nozzle of the laser device, that is to say of the laser head from which the laser beam or beams emanate.

Depending on the case, the method of the invention may comprise one or more of the following characteristics:

the assist gas is an oxygen/nitrogen mixture containing from 92 to 98% nitrogen;

the optical means is chosen from lenses, mirrors and combinations thereof, preferably a lens, such as a bifocal lens, that is to say one which focuses the beam at two separate focusing points;

the assist gas is oxygen containing less than 500 ppm by volume of argon as impurities, preferably from 0 to 100 ppm by volume of argon;

the assist gas is a nitrogen/oxygen mixture having an oxygen content greater than 0% by volume and less than 8% by volume, preferably an oxygen content between 150 ppm by volume and 5% by volume, the rest being nitrogen and possibly inevitable impurities;

the optical means of the bifocal type is arranged so as to obtain at least one first focusing point positioned near the upper surface of the workpiece to be cut, preferably so as to coincide with said upper surface, or in the thickness of the workpiece to be cut in a region close to said upper surface, and at least one second focusing point positioned near the lower surface of the workpiece to be cut and in the thickness of the latter, or beyond the latter;

the thickness of the workpiece to be cut is between 1.5 mm and 5 mm and, for this thickness, a laser source of 1800 watts power is used, for example;

the workpiece to be cut is chosen from plates, sheets and tubes;

the nitrogen/oxygen mixture is obtained directly on the site of use from atmospheric air treated by a membrane system.

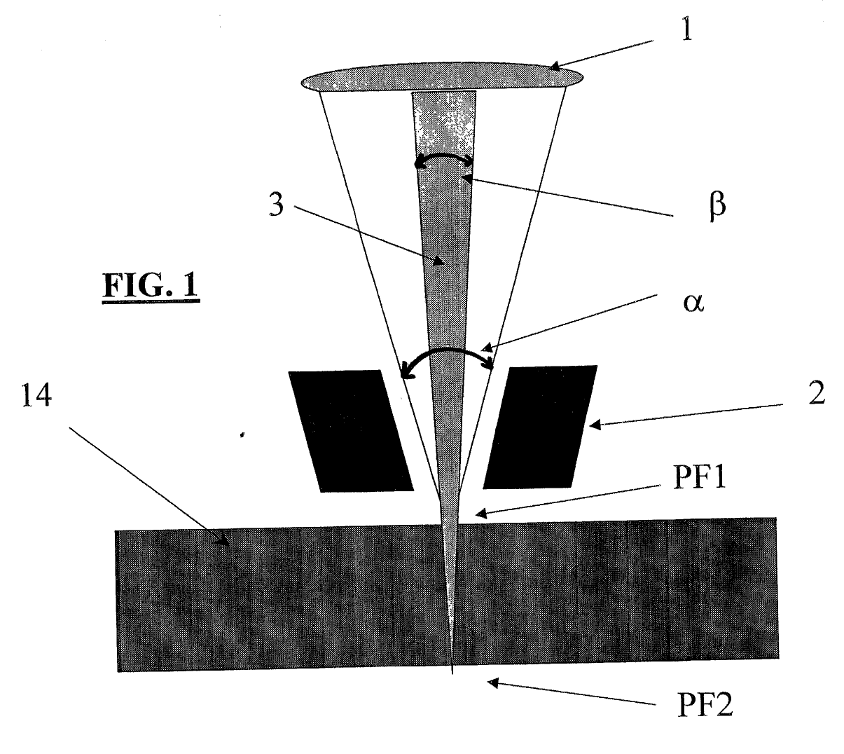

In other words, as shown schematically in FIG. 1, the invention relies on the use, in combination, on the one hand, of one or more transparent or reflecting optical components 1, such as lenses or mirrors, making it possible to obtain several separate focusing points PF1, PF2 for the laser beam 3, approximately along the same axis and, on the other hand, of oxygen or of an oxygen/nitrogen mixture as assist gas, i.e. as cutting gas, in order to cut certain types of materials, especially aluminum and its alloys.

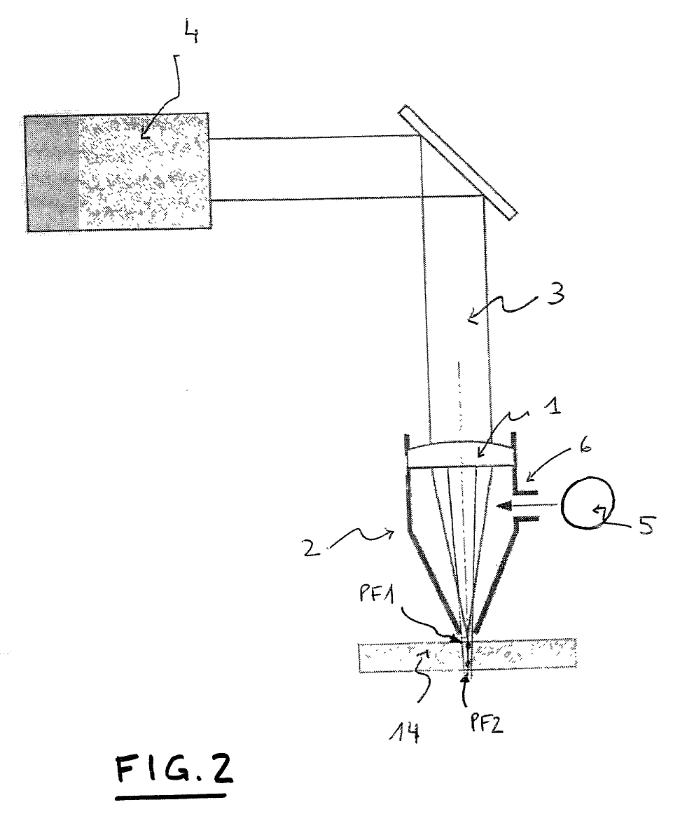

An apparatus for cutting a workpiece 14 made of stainless steel, coated steel, for example painted steel, aluminum or aluminum alloy according to the invention is shown schematically in FIG. 2.

This apparatus comprises at least one laser generator 4 for generating at least one laser beam 3, at least one output nozzle 2 through which said laser beam 3 passes, at least one transparent or reflecting optical means 1 for focusing said laser beam 3 and at least one source 5 of assist gas for said laser beam 3 feeding said output nozzle 2 with assist gas, the assist gas being introduced into the nozzle 2 via one or more gas inlet orifices 6 through the peripheral wall of the nozzle 2.

According to the invention, the optical means 1 is of the multifocus type, preferably a multifocus lens making it possible to obtain two separate focusing points, and the source 5 of assist gas feeds the nozzle 2 with nitrogen or with a nitrogen/oxygen mixture.

The laser source is of the CO₂ type or of the YAG type, preferably CO₂.

Transparent or reflecting optical components 1 having several focusing points that can be used within the context of the present invention are described in document WO-A-98/14302 or in documents DE-A-2713904, DE-A-4034745, JP-A-01048692 or JP-A-56122690.

As shown in detail in FIG. 1, the first focusing point PF1 arising from the wider convergence angle, in this case the angle α, lies near the upper surface of the workpiece 14 to be cut, preferably so as to coincide with said upper surface, or in the thickness of the material in a region close to said upper surface.

The second focusing point PF2 arising from the smaller convergence angle, in this case the angle β, lies near the lower surface of the workpiece 14 in the thickness of the material or beyond the latter.

This principle makes it possible, compared with the use of a standard optical component employed in the cutting of structural steel under nitrogen, to use smaller nozzle diameters and therefore to reduce the consumption of gas.

This is because the use of a standard optical component, i.e. one having only a single focusing point, necessitates positioning its single focusing point, and therefore the one for which the convergence angle is the greatest, at the lower face of the material, or indeed below it. Consequently, in order to allow passage of the laser beam, it is necessary to use large-diameter nozzles, typically at least 2 mm in diameter, this diameter being greater the thicker the workpiece, and this therefore correspondingly increases the gas consumption.

On the other hand, according to the present invention, by combining a bifocal optical component 1, that is to say a component having at least two focusing points PF1 and PF2 which are separate from one another, with oxygen or a nitrogen/oxygen mixture, not only is gas consumption decreased as mentioned above, but also the presence of an oxide on the cut faces is eliminated or greatly reduced, particularly in the case of the cutting of stainless steels, coated steels, aluminum and aluminum alloys.

In other words, the method of the invention makes it possible to increase the cutting performance in stainless steels, coated steels, aluminum and aluminum alloys and to limit the consumption of cutting gas while at the same time obtaining an economically favorable end result with respect to oxygen by including the saving on finishing.

A nitrogen/oxygen mixture that can be used in the context of the invention may be obtained, for example, directly on the site of use from atmospheric air treated by a membrane system so as to reduce its oxygen content down to the desired level.

A membrane system of this type is sold by L'AIR LIQUIDE under the name FLOXAL™.

However, the nitrogen/oxygen mixture may also be obtained conventionally by mixing nitrogen and oxygen in the desired proportions.

The method of cutting stainless steels, coated steels, aluminum and aluminum alloys with a laser beam using a bifocal lens or mirror according to the invention results in high cutting rates, i.e. from about 0.9 m/min to about 5.9 m/min depending on the thicknesses, these being combined with reduced cutting gas flow rates, typically no more than 19 m³/h, and the production of low-cost cut workpieces, particularly for a laser source of 1800 W power, for example.

1. A method of cutting a workpiece made of stainless steel, coated steel, aluminum or aluminum alloy by the use of at least one transparent or reflecting optical means for focusing at least one laser beam and of at least one assist gas for said laser beam, in which the optical means is of the multifocus type and the assist gas is oxygen or an oxygen/nitrogen mixture.

2. The method as claimed in claim 1, wherein the multifocus optical means is chosen from lenses, mirrors and combinations thereof, preferably a bifocal lens.

3. The method as claimed in either of claims 1 and 2, wherein the assist gas is an oxygen/nitrogen mixture containing at least 90% nitrogen, preferably from 92 to 98% nitrogen.

4. The method as claimed in one of claims 1 to 3, wherein the assist gas is oxygen containing less than 500 ppm by volume of argon as impurities, preferably less than 100 ppm by volume of argon.

5. The method as claimed in one of claims 1 to 4, wherein the assist gas is a nitrogen/oxygen mixture having an oxygen content greater than 0% by volume and less than 8% by volume, preferably an oxygen content between 150 ppm by volume and 5% by volume, the rest being nitrogen.

6. The method as claimed in one of claims 1 to 5, wherein the optical means is arranged so as to obtain at least one first focusing point positioned near the upper surface of the workpiece to be cut, preferably so as to coincide with said upper surface, or in the thickness of the workpiece to be cut in a region close to said upper surface, and at least one second focusing point positioned near the lower surface of the workpiece to be cut and in the thickness of the latter, or beyond the latter.

7. The method as claimed in one of claims 1 to 6, wherein the thickness of the workpiece to be cut is between 1.5 mm and 5 mm.

8. The method as claimed in one of claims 1 to 7, wherein the workpiece to be cut is chosen from plates, sheets and tubes.

9. The method as claimed in one of claims 1 to 8, wherein the nitrogen/oxygen mixture is obtained directly on the site of use from atmospheric air treated by a membrane system.

10. An apparatus for cutting a workpiece made of stainless steel, coated steel, aluminum or aluminum alloy, comprising:
at least one laser generator for generating at least one laser beam;
at least one output nozzle through which said laser beam passes;
at least one transparent or reflecting optical means for focusing said laser beam; and
at least one source of assist gas for said laser beam feeding said output nozzle with assist gas, wherein:
the optical means is of the multifocus type, and
the source of assist gas feeds the nozzle with oxygen or with a nitrogen/oxygen mixture, preferably containing at least 90% nitrogen.
